(19) United States
(12) Patent Application Publication
(10) Pub. No.: US 2005/0150276 A1
(43) Pub. Date: Jul. 14, 2005

(54) IN-SITU MEASUREMENT OF WATER OF HYDRATION IN POLYELECTROLYTE MEMBRANE (PEM) OF FUEL CELL

(75) Inventor: GERALD SCHULTZ, BROOKLINE, MA (US)

Correspondence Address: DYKEMA GOSSETT PLLC, 2723 SOUTH STATE STREET, SUITE 400, ANN ARBOR, MI, 48104, US

(73) Assignee: GENERAL ELECTRIC COMPANY, PLAINVILLE, CT (US)

(21) Appl. No.: 10/707,760

(22) Filed: Jan. 9, 2004

(51) Int. Cl. G01N 5/02

(52) U.S. Cl. 73/73

(57) ABSTRACT

A method and Apparatus for measuring water of hydration in a polyelectrolyte membrane (PEM) employs a source of input radiation directed at an input location on the PEM, and a detector responsively positioned at an output location relative to the input location for determining a sensible change in the input radiation indicative of a level of water hydration in the PEM. The method measures hydration of the (PEM) by forming an input location in the PEM; launching a source of radiation into the input location for reaction with the PEM material; detecting the reaction of the input radiation with the PEM material; and determining a sensible change in the input radiation as a result of the reaction indicative of a level of water hydration in the PEM.

### BACKGROUND OF INVENTION

The invention relates to a method and apparatus for in-situ measurement of water of hydration in a polyelectrolyte membrane (PEM) of a fuel cell stack. In particular, the invention is directed to a method and apparatus employing a light source or other source of radiation which is responsive to changes in the concentration of water of hydration present in the PEM. In the case of IR radiation, secondary information may be gained regarding the state of water i.e. the energy by which water is bound to the PEM by means of shifts in frequency of absorbed radiation. In addition, changes in the condition of the PEM itself due to chemical reactions can be monitored by the disappearance and appearance of characteristic absorption frequencies of the native PEM and reaction products, respectively.

Fuel cells employ a polyelectrolyte membrane which relies on the transport or diffusion of hydrogen ions therethrough produce an electrical output. Water of hydration affects the efficiency of fuel cells because it reduces the energy of activation, i.e. thereby reducing the mobility of the hydrogen ion as it diffuses across the membrane.

It is difficult to directly measure this parameter. Current methods include the use of a humidity sensor which measures water of hydration indirectly through the equilibrium water vapor concentration in the ambient environment of the PEM.

Another method measures the degree of hydration of the PEM by measuring the electrical resistance or capacitance of the membrane. This method has a significant disadvantage, in that, contact resistance between the membrane and the contact electrodes may degrade with fuel cell aging, thereby adversely affecting the accuracy of the measurements. Also, the method does not account for degradation of the PEM itself which occurs over time.

It is therefore an object of the invention to directly measure water of hydration in a polyelectrolyte membrane. It is also an object of the invention to monitor the chemical integrity of the PEM or any hydrolysis process which varies over time, and to insure optimal hydration by means of an appropriate control process. It is yet another object of the invention to achieve a measure of water of hydration using a non invasive technique.

### SUMMARY OF INVENTION

The invention is based on the discovery that water of hydration in a polyelectrolyte membrane (PEM) may be measured by sensing a change in the transmission or absorption of light energy as it interacts with water in a PEM. In a particular embodiment the invention comprises an apparatus for measuring water of hydration in a polyelectrolyte membrane (PEM) including a source of input radiation directed at an input location on the PEM; and a detector responsively positioned at an output location relative to the input location for determining a sensible change in the input radiation indicative of the level of water of hydration in the PEM.

### BRIEF DESCRIPTION OF DRAWINGS

FIG. 1 is a schematic illustration of simplified fuel cell employing a polyelectrolyte membrane (PEM).

FIG. 2 is a schematic illustration of an apparatus for in-situ measurement of water of hydration in a PEM.

FIG. 3 is an example of an infra-red absorbance spectrum of a Nafion based PEM as a function of relative humidity at 25° C.

FIG. 4 is a schematic illustration of another embodiment of the invention employing a radiation source and detector having a fluorescent dye bound to the PEM matirx.

FIG. 5 is a schematic illustration of an alternative embodiment showing input and output fibers disposed on one side of the PEM.

### DETAILED DESCRIPTION

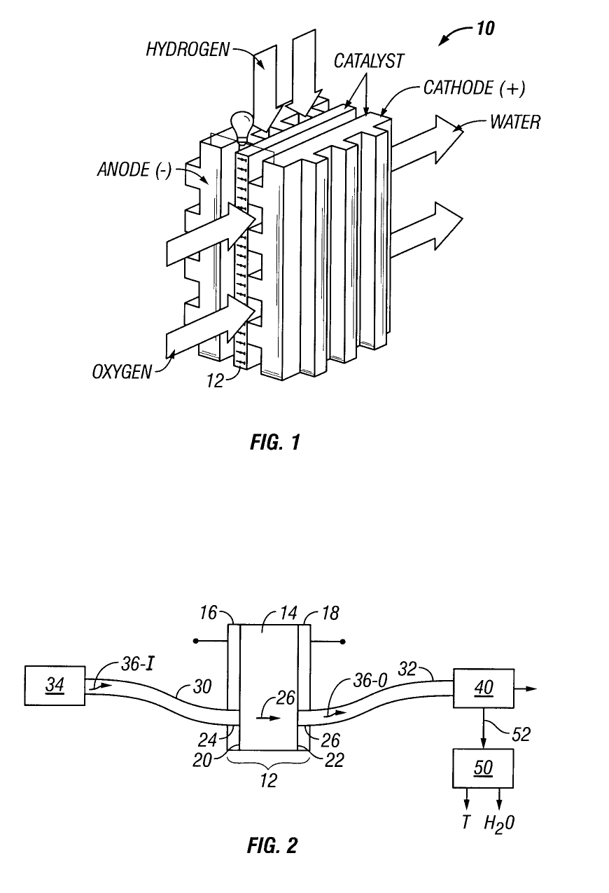

The invention is illustrated in FIG. 1, wherein a fuel cell element 10 has a polyelectrolyte membrane 12 (PEM) disposed therein. According to known principles, the PEM facilitates the transport of hydrogen ions H+ across the PEM for reaction with oxygen ions, to produce electrical current and waste water, as shown.

The PEM 12 (FIG. 2) comprises a film or core layer 14 formed of a perfluorinated polymer such as a material manufactured by Dupont sold under the name Nafion. The core has carbon electrodes 16 and 18 formed on opposite surfaces 20 and 22. The carbon electrodes 16 and 18 may be a carbon impregnated outer layer of the film. In an exemplary embodiment, the electrodes 16 and 18 have respective apertures or windows 24 and 26 formed therein. The windows are aligned as shown.

FIG. 1 further illustrates an arrangement employing a processor 50 for analyzing the detected energy. The detector 40 produces a control output 52. The processor 50 may interpret the output to determine not only the hydration H+ level but also the temperature T of the fuel cell 10. The thermodynamic potential for water is more than 10 kcal/mole; the temperature of the cell may be determined from the hydration measurement. The temperature may be used as a control signal for regulating the operation of the fuel cell in a closed loop feedback loop.

Respective input and output optical fibers or waveguides 30 and 32 are secured in the respective windows 30 and 26 as shown. A suitable radiation source 34 launches input light 36-I into the input waveguide 24 which is carried to the PEM through the window 24. The light 36 enters the PEM through the window 24, and depending on the hydration level, the light is selectively attenuated and carried as output light 36-O to the output waveguide 32 through window 26. The light may be wave shifted due to hydrogen bonding. Also, a change in characteristic absorption frequency of PEM would occur due to chemical reactions. The output light 36-O is carried by the output waveguide 32 to a detector 40 which measures the light attenuation and provides a measure of the hydration level of the PEM.

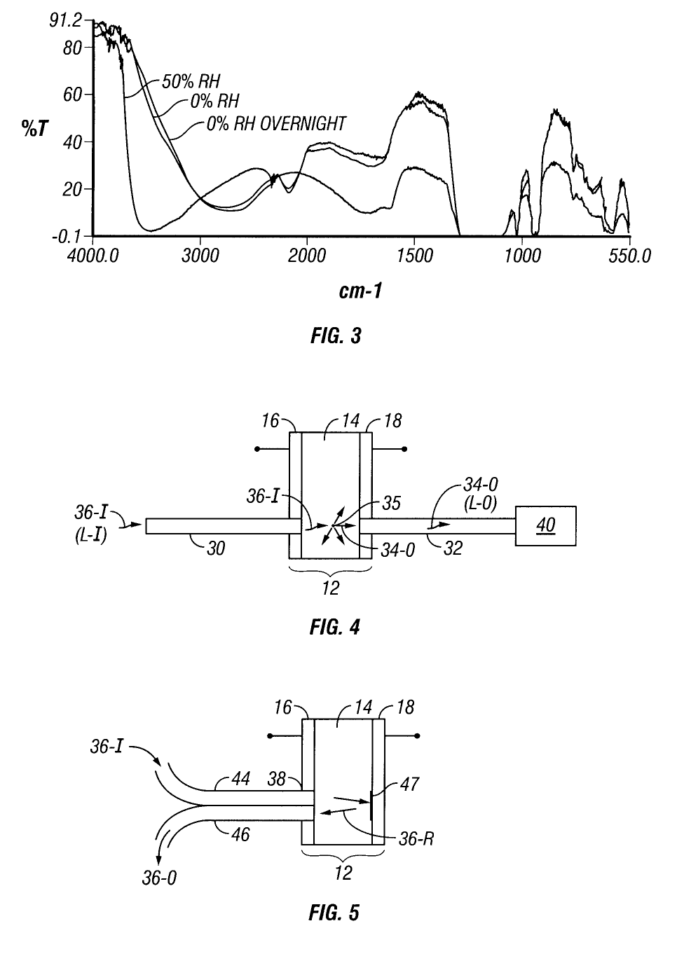

Water has certain known absorption bands 44 and 46 for radiation in the infra-red (IR) region as shown in FIG. 3. The absorption bands 44 and 46 are in the regions of 6 and 3 microns. These regions in the IR represent primary absorption modes and exhibit larger extinction coefficients than in the near infra-red region.

In an exemplary embodiment, the light source 34 may be an IR or near infra-red source. FIG. 3 illustrates the infra-red absorption of Nafion in three ambient environments at different relative humidities. The degree of hydration of the Nafion membrane is directly related to the ambient relative humidity. As hydration increases, more light is absorbed at its characteristic wavelengths.

In an alternative embodiment, the bulk index of refraction of the PEM will change with hydration, causing a corresponding displacement in the refracted ray. The detector 40 measures this change and produces a corresponding hydration measurement.

In yet another embodiment, shown in FIG. 4, the light source 34 may be a light having a selected wavelength L-I which is launched as input light 36-I into the PEM 12. The material forming the PEM may contain fluorophores 35 in the form of a fluorescent dye molecules bound to the PEM matrix 14. The dye 35 absorbs the input light 34-I and re-emits output light as 34-O at a longer wavelength L-O. The output light 34-O is carried to the output waveguide 32 to a detector 40 which in the exemplary embodiment is responsive to the output wavelength L-O. Water molecules cause fluorescence quenching. Suitable dyes have the attributes of temperature stability at around 100 degrees C. and can be covalently bound to the PEM matrix. The dyes 35 include functionalized perylenes and binaphthyls, and dihydroxybipyridyles.

In the illustration of FIG. 5, where similar reference numerals are used for similar elements, the input window and output window comprise a single aperture 38 formed in the same side of the PEM. In the illustration, input light 36-I may be launched into fiber 44 through aperture 38. The input light 36-I passes through the aperture or window 38 and through the PEM. The light is reflected by reflector 47 disposed opposite the window 38, as shown. Reflected light 36-R is directed towards the window 38 and enters the output fiber 46 therethrough producing the output light 36-O which is coupled to a detector, not shown. In an arrangement where the PEM contains fluorescent dyes, which radiate in all directions, the reflector 47 may be eliminated, because the fluorescent light may be detected from the vantage point of the input light.

It should be understood that the invention may be employed in any environment where it is necessary to measure humidity or water content directly. These may be harsh environments where other methods of water detection are not practical. It is also contemplated that other radiation sources may be employed in the invention where such sources may produce a sensible response to the water content of the PEM.

1. Apparatus for measuring water of hydration in a polyelectrolyte membrane (PEM) comprising:
a source of input radiation directed at an input location on the PEM; and
a detector responsively positioned at an output location relative to the input location for determining a sensible change in the input radiation indicative of a level of water hydration in the PEM.

2. Apparatus according to claim 1, wherein the radiation is at least one of infra-red, near infra-red, visible, and ultraviolet.

3. Apparatus according to claim 1, wherein the sensible change is a change in at least one of absorption; fluorescence and refractive index.

4. Apparatus according to claim 1, including means for carrying the input radiation to the input location; and
means for carrying the sensibly changed input radiation to the detector.

5. Apparatus according to claim 4, wherein the means for carrying input radiation and the output radiation comprises an optical waveguide.

6. Apparatus according to claim 1, further comprising a window in the PEM for optically connecting the input and output locations.

7. Apparatus according to claim 6, wherein the window comprises a portion of the PEM formed without electrode overcoating.

8. Apparatus according to claim 1, wherein the PEM includes a fluorophore operative to produce fluorescence in response to the input radiation.

9. Apparatus according to claim 8, wherein the water of hydration present in the PEM selectively quenches the fluorescence in accordance with the concentration thereof in the PEM.

10. Apparatus according to claim 1, wherein the PEM is in a fuel cell and further including means for determining the temperature of the fuel cell as a function of water of hydration present in the PEM.

11. Apparatus according to claim 1, further including processor means for producing a control output in response to the output signal.

12. Apparatus according to claim 1, wherein the PEM includes a material selected from the group comprising a perfluorinated polymer.

13. Apparatus according to claim 1, wherein the PEM includes a dye selected from the group comprising functionalized perylenes and binaphthyls; and dihydroxybipyridyles.

14. Apparatus according to claim 1 wherein the PEM has opposite surfaces and includes an electrode material disposed on each of the opposite surfaces, and wherein the input location comprises an aperture formed in the electrode material.

15. Apparatus according to claim 1 wherein the PEM has opposite surfaces and includes an electrode material disposed on each of the opposite surfaces, and wherein the output location comprises an aperture formed in the electrode material.

16. Apparatus according to claim 1, wherein the PEM has opposite surfaces and includes an electrode material disposed on the opposite surfaces, and wherein the input and output locations comprise at least one of an aperture formed in respective ones of the contact layers wherein input light is launched and output light is received.

17. Apparatus according to claim 16 wherein the input and output windows are optically aligned on opposite sides of the PEM.

18. Apparatus according to claim 1, where in the PEM has opposite surfaces and includes an electrode material on each of the opposite surfaces, and wherein the input and output locations comprise at least one aperture formed in a selected one of the contact layers, wherein input light is launched and output light is received through the aperture in the selected one of the contact layers.

19. Apparatus according to claim 16 wherein the input and output windows are disposed on the same side of the PEM.

20. Apparatus according to claim 1, wherein a reflector is disposed on a surface of the PEM opposite the aperture for reflecting input light towards the aperture.

21. A method for measuring hydration of a polyelectrolyte membrane (PEM) formed of a selected material comprising the steps of:
forming an input location in the PEM;
launching a source of radiation into the input location for reaction with the PEM material;
detecting the reaction of the input radiation with the PEM material; and
determining a sensible change in the input radiation as a result of the reaction indicative of a level of water hydration in the PEM.

22. The method of claim 21, wherein the radiation comprises energy including at least one of infra-red, near infra-red, visible, and ultraviolet.

23. The method of claim 21, wherein the sensible change is a change in at least one of absorption; and fluorescence of the input radiation.

24. The method of claim 21, wherein the PEM has an electrically conductive coating on opposite surfaces thereof and forming an input location comprises forming a window in at least one electrode on the PEM.
